(19) United States
(12) Patent Application Publication
(10) Pub. No.: US 2014/0232556 A1
(43) Pub. Date: Aug. 21, 2014

(54) WIRELESS, MULTI-POINT PATIENT MONITORING SYSTEM

(71) Applicant: Rondish Company Limited, Kwai Chung (CN)

(72) Inventor: Steven Alfred Williams, Kwai Chung (CN)

(73) Assignee: Rondish Company Limited, Kwai Chung (CN)

(21) Appl. No.: 14/184,092

(22) Filed: Feb. 19, 2014

Related U.S. Application Data
(60) Provisional application No. 61/766,230, filed on Feb. 19, 2013.

(51) Int. Cl. G08C 17/02

(52) U.S. Cl. CPC G08C 17/02
USPC 340/870.09

(57) ABSTRACT

A patient monitoring system has a central monitoring point which wirelessly communicates with multiple patient sensor systems. The central monitoring point and each sensor system has at least one transceiver. Routine communication between the central monitoring point and the patient sensor systems is initiated by the central monitoring point's transceiver. The response, or lack thereof, from each patient sensor system's transceiver is used by the central monitoring point to determine if an alarm condition exists. Communication of an alarm condition can also be sent from a patient sensor system to the central monitoring point and then confirmed to ensure that the signal is from a device or sensor system that is found on a list of devices and systems stored in the memory of the central monitoring point.

### CROSS-REFERENCE TO RELATED APPLICATIONS

This application claims benefit of U.S. Provisional Application No. 61/766,230, titled “WIRELESS, MULTI-POINT PATIENT MONITORING SYSTEM,” filed Feb. 19, 2013, the disclosures of which is hereby incorporated by reference in its entirety herein.

### BACKGROUND

The present disclosure relates to systems, methods, and apparatuses for monitoring the status of a patient using multiple sensor systems and a central monitoring point. The sensor systems and the central monitoring point communicate wirelessly through transceivers within each of the sensor systems and the central monitoring point.

Patient monitoring systems are often based upon a wired connection between a sensor system, such as a bed-pad or floor mat, and a monitoring apparatus located either next to the patient or at times away from the patient, such as at a nurses' station. When multiple types of sensors and sensor systems are used to monitor a patient for unwanted movement, such as falls, wired connections can become burdensome and a safety hazard.

Sensor systems can be equipped with transmitters that send status information regularly and indiscriminately. Such unsolicited data transfer from a sensor system can require much power and processing resources from the sensor system. Additionally, when data is sent indiscriminately, the potential for inadvertent cross-talk or interference is higher. The time needed to detect a faulty sensor or sensory system can also be higher in such systems.

### SUMMARY

Disclosed is a patient monitoring system that includes at least one sensor system and a central monitoring point, wherein the sensor system and the central monitoring point communicate wirelessly via transceivers, with communication initiated or confirmed by the central monitoring point.

Provided in some implementations is a system for monitoring a patient that includes a sensor system, a central monitoring point, and signal receiving unit. The sensor system sends information about the patient's status, and the sensor system includes a first transceiver and a first memory. The central monitoring point receives the information about the patient's status from the sensor system, and the central monitoring point includes a central transceiver, a central memory, and an alarm system. The signal receiving unit receives the information about the patient's status and relays that information to an environmental control device. The sensor system includes at least one of a bed pad sensor system, a floor mat sensor system, and a motion detector sensor system.

The following features can be present in the system in any suitable combination. In some implementations, the environmental control device can include a lamp, a lighting array, or both a lamp and a lighting array. The system can further include an environmental sensor. The environmental sensor can include a light sensor in some such implementations. The system can include a processor that implements a time of day mode.

In such systems, the time of day mode can include a time of day protocol that adjusts the patient's environment based upon a current time of day and a current patient status. The time of day protocol can adjust lighting levels in the patient's environment based on the current time of day as determined by the current lighting levels. The time of day protocol can adjust lighting levels in the patient's environment based on the current time of day as determined by the current movement levels in the patient's room. Further, the time of day protocol can adjust alarm volume levels in the patient's environment based on the current time of day as determined by the current lighting levels. In some implementations of a system with a processor that implements a time of day mode, the time of day protocol can adjust alarm volume levels in the patient's environment based on the current time of day as determined by the current movement levels in the patient's room.

Also presented herein are methods for monitoring a patient using the system described above, as well as methods for adjusting a patient's environment using the system described above.

Other features and advantages should be apparent from the following description of various embodiments, which illustrate, by way of example, the principles of the disclosure.

### BRIEF DESCRIPTION OF THE DRAWINGS

FIG. 1 is a schematic of a patient monitoring system that includes multiple sensor systems, a central monitoring point, and a user, in which communication between the central monitoring point and the sensor systems is wireless;

FIG. 2 is a flow diagram showing potential flows of data and communication in a patient monitoring system;

FIG. 3A is a schematic of signaling and lighting control in a wireless sensor system;

FIG. 3B is a flow diagram showing a method for operating lighting in a patient's environment using a sensor system;

FIG. 4A is another schematic of signaling and lighting control in a wireless sensor system; and

FIG. 4B is flow diagram showing another method for operating lighting in a patient's environment using a sensor system.

### DETAILED DESCRIPTION

A patient monitoring system that includes at least one sensor system and a central monitoring point is described herein. The sensor systems and the central monitoring point communicate wirelessly via transceivers, with communication initiated by, confirmed by, or both initiated and confirmed by the central monitoring point. Such directed, or structured, communication reduces the likelihood of signal clash or interference, false alarm or missed alarms, or other types of transmitter failures; increases the likelihood of quickly discovering faulty sensor systems, and can increase data transmission security while increasing battery life for sensor systems.

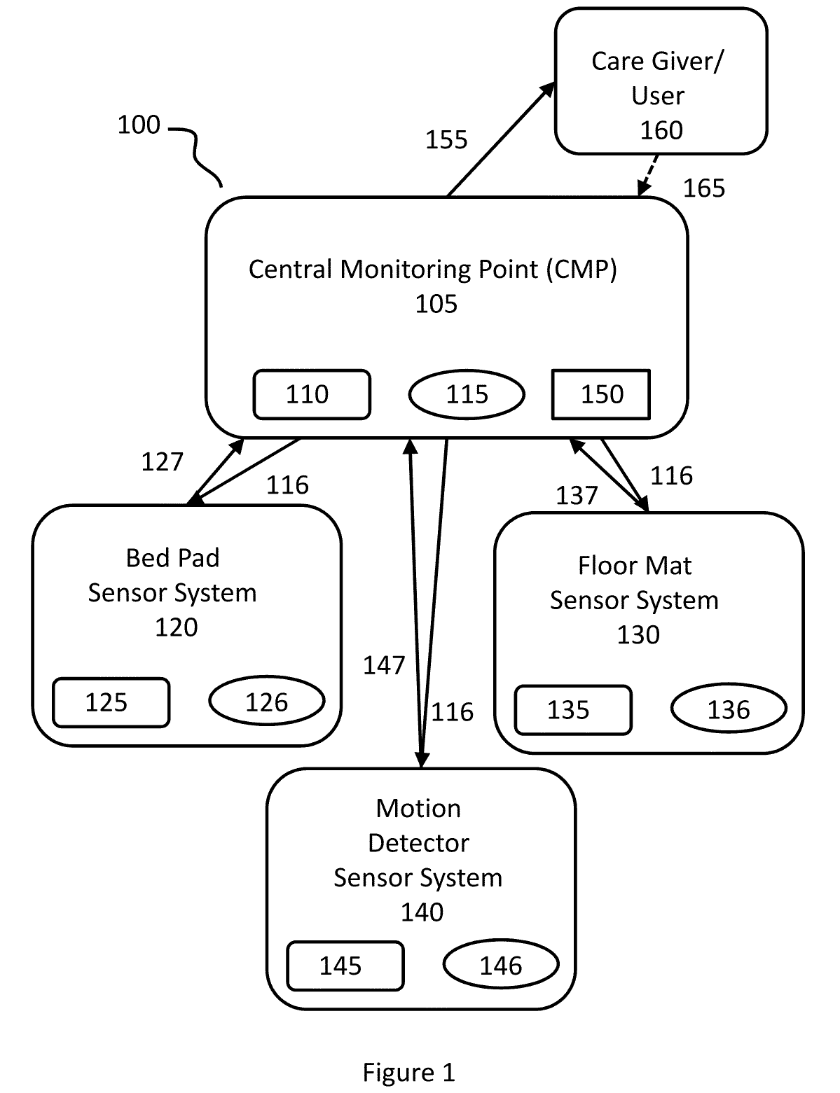

FIG. 1 is a schematic of a patient monitoring system 100 that includes multiple sensor systems 120, 130, 140; a central monitoring point 105; and a care giver or user 160, in which communication between the central monitoring point 105 and the sensor systems 120, 1230, 140 is wireless. The central monitoring point 105 of the patient monitoring system 100 has a transceiver 110, memory component 115, and an alarm system 150. The patient monitoring system 100, as shown, has three sensory systems: a bed pad sensor system 120, a floor mat sensor system 130, and a motion detector sensor system 140. Each sensor system has a transceiver 125, 135, and 145, as well as a memory component 126, 136, and 146. The care giver or user 160 can be thought of as a part of the patient monitoring system 100, as he or she will interact with the system as described in further detail below.

The central monitoring point (CMP) 105 sends out queries 116 at predetermined, regular intervals to the bed pad sensor system 120, the floor mat sensor system 130, and the motion detector sensor system 140. The CMP transceiver 110 sends the queries and receives any responses. The sensor system transceivers 125, 135, and 145 receive the queries 116. If the each sensor system is operating correctly, each system retrieves information from its memory component 126, 136, and 146. The information can be the sensor system's current status or history information, including status history. The transceiver 125, 135, and 145 of each sensor system sends a response 127, 137, and 147 back to the transceiver 110 of the central monitoring point 105. Each response 127, 137, and 147 can be stored in the memory component 115 of the central monitoring point 105. The CMP 105 and the sensor systems can be located in the same room or in different rooms. The CMP 105 can be located in a nurses' station or near a doorway or other entrance to a ward.

In some cases, the central monitoring point 105 will not receive a response 127, 137, or 147 from one or more of the sensor systems. In such a case, after a predetermined amount of time has lapsed after the first query, the CMP 105 can repeat the query 116. The amount of time before a follow-up query is sent can be less than one minute, such as 45 seconds or less, or even 30 seconds or less.

Based upon the responses 127, 137, and 147, or lack thereof, the central monitoring point 105 determines whether an alarm condition exists. An alarm condition can include lack of response from at least one sensor system within the predetermined amount of time and after sending a query at least 3 times. An alarm condition can also include an indication from at least one sensor system that a patient has moved, such as out of bed or away from a specific area. An alarm condition can require that at least two sensor systems indicate that a patient has moved or changed condition.

An alarm condition can be indicated by at least one sensor system. When an alarm condition occurs, the sensor system that detects the alarm condition can send an indication of the alarm condition to the central monitoring point 105 without initiation from the central monitoring point 105. Communication of an alarm condition that is initiated by the sensor system can be confirmed to ensure that the signal is from a device or sensor system that is found on a list of devices and systems stored in the memory of the central monitoring point.

Once an alarm condition has been determined, the alarm system 150 activates. The alarm system 150 can activate an alarm signal, such as messages, visual indicators, audio indicators, or any combination thereof. The alarm system 150 can provide an alarm signal and other indicators of the alarm condition at the central monitoring point 105 or to a remote location.

A care giver or user 160 receives alarms 155 from the central monitoring point 105 of the patient monitoring system 100 when appropriate. Additionally, the care giver or user 160 can provide feedback or instructions 165 to the patient monitoring system 100 via the central monitoring point 105. Such feedback can control the central monitoring point 105 or any of the sensor systems, or the feedback may be used as instructions for other care givers, such as instructions from a doctor to a nurse in response to the alarm 155. Alternatively, in response to an alarm 155, a care giver or user 160 can interact directly with one or more sensor systems to ensure the health and safety of a patient and rectify the alarm condition.

The alarm signal can be an audio signal, a visual signal, or both an audio and visual signal. An audio signal can be a sustained sound, an instantaneous sound, and/or a repeating sound. A visual signal can be a flashing light, an indicator light, a message on a user interface, or any combination thereof. A message can be a message on a user interface, a message sent to an external device, or an audio message. A message can also be an audio telephonic message sent to a land-line, a mobile phone, or a voice-mail account. Additionally, a message can be a text-based or icon based message, such as a short message service message (i.e. SMS text message), an e-mail, or a multimedia messaging service message received on a mobile phone, pager, or hand-held device that is configured to send and receive data using cellular phone signaling means.

Many types of sensor systems can be used with the patient monitoring system described herein. Such systems include those which utilize passive infrared (PIR) sensors, infrared beam sensors, bed-pads, floor mats, straps, and other devices. U.S. patent application Ser. No. 12/606,043 describes one type of sensor pad. This type of sensor pad has one zone on each plate. An alternative type of sensor pad is described in U.S. Provisional Patent Application Ser. No. 61/723,940, and a strap patient monitoring system is described in U.S. Pat. No. 8,375,522. All of the aforementioned references which describe potential sensor and monitoring systems for use with the described patient monitoring system are incorporated by reference herein in their entirety.

The patient monitoring system with a central monitoring point wirelessly connected to multiple sensor systems can be used in any situation where monitoring of a patient or individual is desired. For example, central monitoring point can be communicatively coupled to a Personal Emergency Alarm System (PERS) for on-site assisted living accommodation, to a nurses' station or off-site alarm relay via the telephone network or internet, to alert family, friends, caregivers, control centers, or any combination thereof. The patient monitoring systems, particularly the central monitoring point, can also be communicatively coupled with Nurse call Systems in hospitals, nursing homes, and other assisted living facilities. Multiple central monitoring points can be used to communicate information to a further aggregating point. An example of this is multiple Zone Protectors which transmit information to a Care Station. Wireless connections between the transceivers in the sensor systems and the central monitoring point of the patient monitor system can utilize any suitable wireless system, such as Bluetooth, WiFi, radio frequency, Zigbee communication protocols, infrared, cellular phone systems, and the like, and can also employ coding or authentication to verify the origin of the information received by either or both the sensor systems and the central monitoring point.

More than one patient associated with at least one sensor system can be monitored simultaneously with a patient monitoring system with a central monitoring point wirelessly connected to multiple sensor systems. To increase the ability to accurately monitor multiple patients, as well as to minimize over-all transmitter failures, the CMP of the patient monitoring system can not only initiate communication with the sensor systems at regular time intervals, the communication between transceivers can be verified, such as by using machine ID codes, serial numbers, encryption keys, or the like. In all cases, the patient monitoring system does not require unsolicited transmission of information by the sensor systems. Since responses are only needed upon query, the number of transmissions by the sensor systems can be reduced. Fewer transmissions from the sensor systems means that less power is needed by a sensor system, and in the cases where the sensor system is battery powered, the battery life can be extended, or smaller power sources can be used.

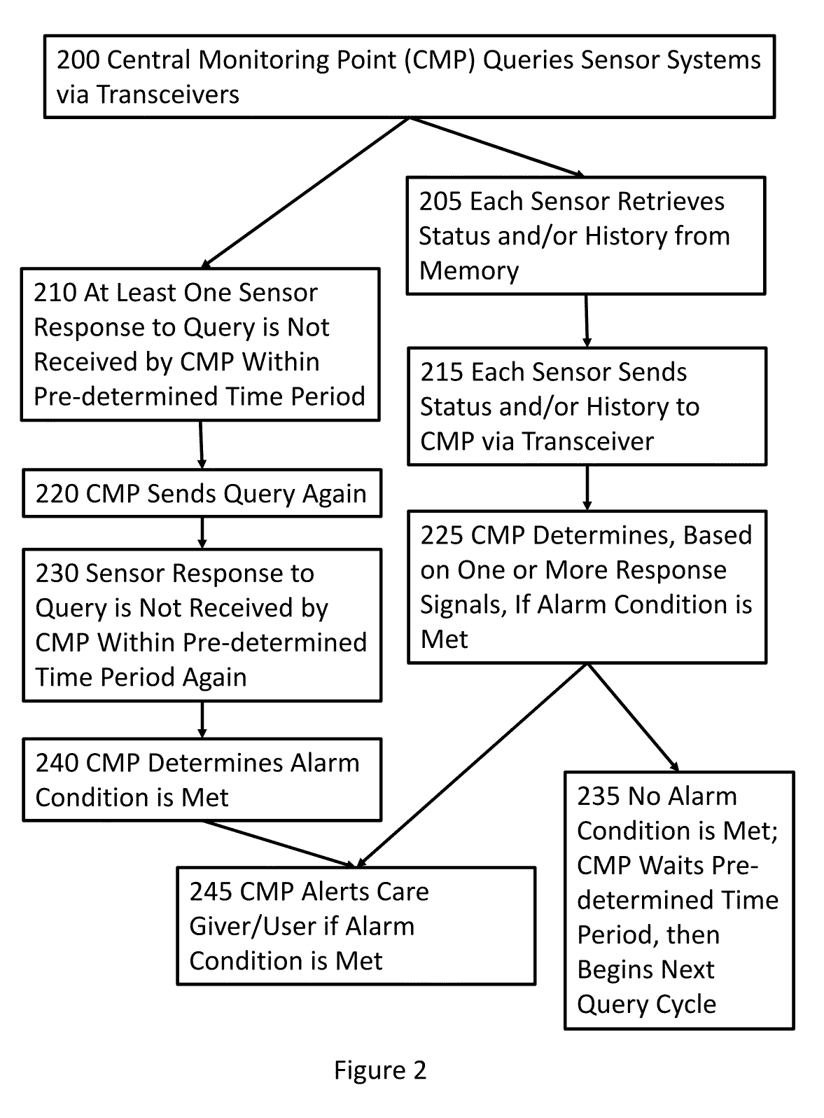

FIG. 2 is a flow diagram showing potential flows of data and communication in a patient monitoring system. Data requests are initiated by the central monitoring point (CMP) of the patient monitoring system. In 200, the CMP queries the sensor systems of the patient monitoring system using wireless means and the transceivers within the CMP and the sensor systems. The CMP sends queries to sensor systems based upon a list of devices and systems stored in its memory component. This list of devices and systems can be updated by a care giver, or user, or by devices, such as in an automatic search for eligible devices.

In some cases, not all systems or devices in the CMP's list of devices or systems respond to the query. When, as in box 210, at least one sensor response is not received by the CMP within a pre-determined time period, as described above, the CMP sends the query again 220. This follow-up query can be sent once, twice, three times, or more. Once the sensor system fails to respond to the query in the predetermined amount of time repeatedly 230, the CMP can determine that an alarm condition is met 240. The determination that an alarm condition has been met will trigger the CMP to alert a care giver or other user 245.

Alternatively, each sensor receives the query from the CMP and, each sensor system retrieves its status, history, or both from its memory component, as in box 205. In box 215, each sensor system sends the data from its memory to the CMP using its transceiver. The communication from the CMP to each sensor system can be a validated communication, such that the ID or serial number of each sensor system is confirmed prior to sending the full query. The ID or serial number of the CMP can be confirmed by each sensor system prior to execution of each query. An ID confirmation can also accompany each response from each sensor system to the CMP.

The CMP determines if an alarm condition is met 225, based on one or more of the responses from the sensor systems. If no alarm conditions are met, then the CMP waits a pre-determined amount of time and then begins the next query cycle, as shown in 235. Conversely, if the CMP determines that an alarm condition is met, as in 245, the CMP alerts a care giver or user. The alarm signal is described in more detailed hereinabove.

The requirement that sensor systems send status and/or history information only upon request can minimize the time the sensor system spends transmitting data, and the verification of the sending and receiving devices in the patient monitoring system can help reduce transmission failure, as well as accelerate the identification of a failed component. This patient monitoring system can accommodate many types of sensor systems placed or located in different positions around a patient, as well as multiple patients with multiple sensor systems.

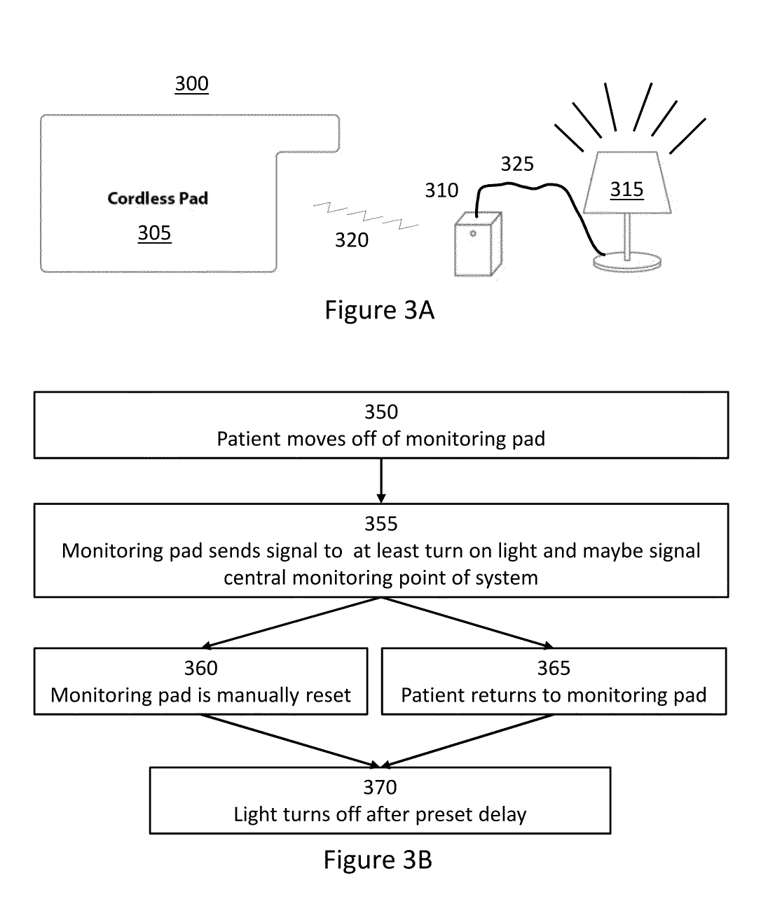

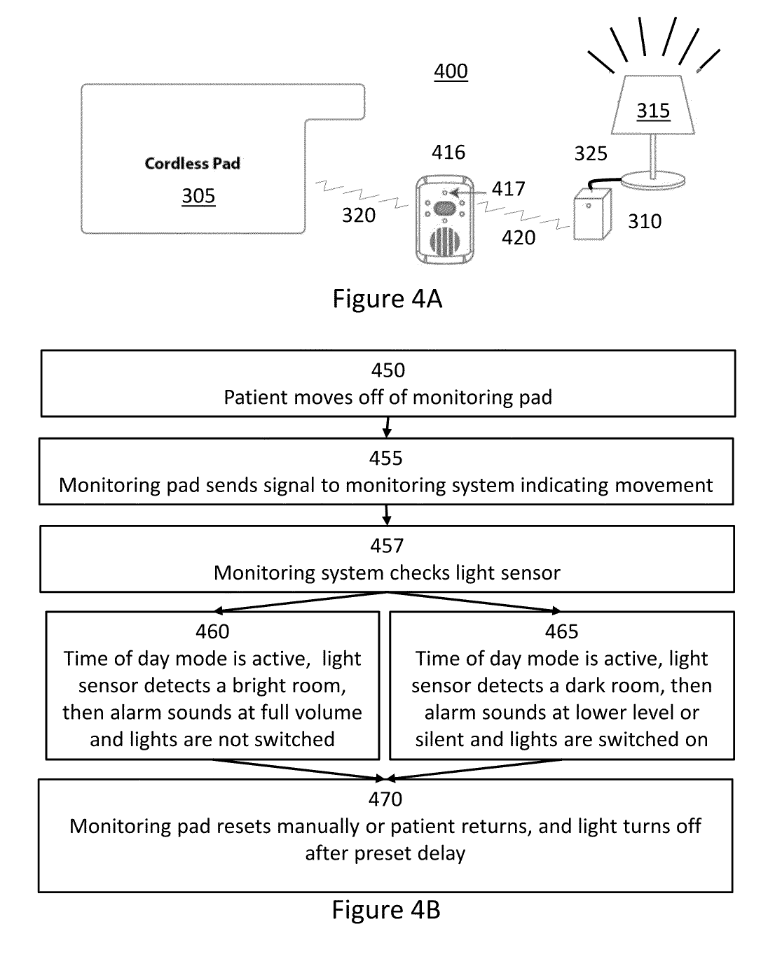

In addition to accommodating many types of sensor systems, the patient monitoring system described herein can also interact with environmental controls. Environmental controls in a patient's room can include lighting controls, door locks, alarm or other sound volume, and the like. FIGS. 3A and 4A are schematics of the interactions between sensors and environmental controls in the patient monitoring system.

In FIG. 3A there is a sensor system 305, such as a cordless bed or floor pad, a signal receiving unit 310, and an environmental control device 315, such as a lamp or lighting array. A signal 320 is sent from the sensor system 305 to the signal receiving unit 310. A signal cable 325 or line exists between the signal receiving unit 310 and the environmental control device 315. The sensor system 305 sends patient data to the central monitoring point (CMP) patient monitoring system, and that patient data can include whether the patient has left his or her bed or chair. The CMP can send the data to the signal receiving unit 315 or the signal receiving unit 315 can receive a signal 320 directly from the sensor system 305 indicating patient status or movement. The signal receiving unit 315 waits until a signal 320 indicates that there is a change in the patient status, for example when the patient gets in or out of bed. Based upon the change in patient status and the current state of the environment, the signal cable 325 controls the environmental control device 315 to suit the actions of the patient.

FIG. 3B describes such control of the environmental control device 315 in response to the actions of the patient. Initially, the patient is sitting in a chair or lying in a bed equipped with a monitoring pad that is a part of a sensor system. At some point, the patient stands up, moving off the monitoring pad, as in box 350. The monitoring pad 305, through the sensor system, sends a signal to the signal receiving unit 315 to turn on the lights in the patient's room, and possibly to signal the patient monitoring system, if the monitoring pad does not signal the central monitoring point directly regarding the change in the patient's environment, as in box 355. The monitoring pad can be manually reset 360, such as by a caregiver who uses a switch or a series of downward pushes on the monitoring pad. Alternatively the patient can return to the monitoring pad, sitting or laying back down, as in box 365. Both the manual reset 360 and the patient returning to the monitoring pad 365 can result in the lights in the patient's room turning off after a preset time delay, as in box 370. The preset time delay can be 20 seconds, 30 seconds, a minute, longer than a minute, or any other time suitable for the patient to settle into his or her chair or bed, as well as for the caregiver to be assured of the patient's safety.

FIG. 4A is similar to FIG. 3A in that there is a sensor system 305, such as a cordless bed or floor pad, a signal receiving unit 310, an environmental control device 315, such as a lamp or lighting array, a signal 320 that is sent from the sensor system 305, and a signal cable 325 between the signal receiving unit 310 and the environmental control device 315. What is different in FIG. 4A is that there is also a patient monitor 416 that is located near the patient and in wireless communication with the central monitoring point. The patient monitor 416, as shown, has a light sensor 417, a speaker, a transmitter, and other features described in greater detail in U.S. Provisional Application Nos. 61/861,266 and 61/861,255. The patient monitor 416 receives the signal 320 that is sent from the sensor system 305 and generates an environmental control signal 420 that is sent to the signal receiving unit 310. In FIG. 4A, the signal 320 sent from the sensor system 305 carries with it patient status information that the patient monitor 416 combines with information it has regarding the patient's environment. The patient monitor then sends one or more environmental control signals 420 to make the environment more suited to the patient's status. The information regarding the patient's environment that the patient monitor 416 has can be obtained from sensors on the patient monitor itself, such as the light sensor 417, from sensors on environmental control devices, or both. Information from an environmental control device about the patient's environment can be used to control that environmental control device or the information can be use to control multiple devices, including the environmental control device that provided the information.

The patient monitor 416, and the patient monitoring system as a whole (100 in FIG. 1), can have an environmental control protocol that corresponds to the time of day. A time of day protocol can be based upon a clock set by a user or that is synchronized with a centralized clock, can be based upon lighting levels in a room, can be based on movement in the room, or any combination thereof. The time of day protocol can have lighting and sound settings that vary based upon the detected time of day or activities within the patient's environment. For example, during the day, when the lighting conditions are bright, or when constant activity is detected in the patient's room, any audio alarms can sound at a high level, lights corresponding to any alarms can flash, and the environmental lights can be maintained at their current level. Conversely, during night time, when lighting conditions are dim or dark, or when little movement is detected in the patient's room, audio alarms can be set to silent or a low audio level, lights that correspond to any alarms may not flash or flash at a dimmer level, and the environmental lights can be raised to allow the patient or care givers to safely see their way around the room.

FIG. 4B provides an exemplary method for controlling the environment in a patient's room using the patient monitoring system with a time of day mode that is shown in FIG. 4A. In this method, the patient is initially sitting in a chair or lying in a bed that includes a sensor system with a monitoring pad. The patient moves off the monitoring pad by standing or sliding off the pad, as in box 450. The monitoring pad sends a signal indicating a change in the position of the patient to the patient monitor, as in box 455. This signal can then alert one or more caregiver that the patient's status has changed, as indicated above. The patient monitor then checks the information it has regarding the current status of the patient's environment. In this case, it checks the light sensor (417 in FIG. 4A) for an indication of the lighting level in the patient's room, as in box 457. Based upon the lighting conditions, the environmental lights can change. In such a case, the lighting sensor can detect that the lighting level of the room is bright, as in box 460, and the time of day protocol can sound alarms at full volume and maintain the lights in their current state; lights that are on will remain on to keep the room bright. Alternatively, the lighting sensor can detect that the lighting level room is low, then alarms can be set to silent or a low audio level and light can be switched on to allow the patient and any care givers to see their way around the patient's room, as in box 465. Once the alarm situation is resolved and the patient returns to his or her position on the monitoring pad, or the monitoring pad is manually reset, the lights in the room can turn off after a preset delay. As indicated with respect to FIG. 3B, the preset delay can be 20 seconds, 30 seconds, a minute, longer than a minute, or any other time suitable for the patient to settle into his or her chair or bed, as well as for the caregiver to be assured of the patient's safety.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, methods of use, embodiments, and combinations thereof are also possible. Therefore the spirit and scope of the appended claims should not be limited to the description of the embodiments contained herein.

What is claimed is:

1. A system for monitoring a patient comprising:
a sensor system that sends information about the patient's status, the sensor system comprising a first transceiver and a first memory;
a central monitoring point that receives the information about the patient's status, the central monitoring point comprising a central transceiver, a central memory, and an alarm system; and
a signal receiving unit that receives the information about the patient's status and relays it to an environment control device;
wherein the sensor system comprises at least one of a bed pad sensor system, a floor mat sensor system, and a motion detector sensor system.

2. The system of claim 1, wherein the environmental control device comprises a lamp, a lighting array, or both a lamp and a lighting array.

3. The system of claim 1 or 2, further comprising an environmental sensor.

4. The system of claim 4, wherein the environmental sensor comprises a light sensor.

5. The system of claim 1, further comprising a processor that implements a time of day mode.

6. The system of claim 5, wherein the time of day mode comprises a time of day protocol that adjusts the patient's environment based upon a current time of day and a current patient status.

7. The system of claim 6, wherein the time of day protocol adjusts lighting levels in the patient's environment based on the current time of day as determined by the current lighting levels.

8. The system of claim 6, wherein the time of day protocol adjust lighting levels in the patient's environment based on the current time of day as determined by the current movement levels in the patient's room.

9. The system of claim 6, wherein the time of day protocol adjusts alarm volume levels in the patient's environment based on the current time of day as determined by the current lighting levels.

10. The system of claim 6, wherein the time of day protocol adjusts alarm volume levels in the patient's environment based on the current time of day as determined by the current movement levels in the patient's room.
